(19) United States
(12) Patent Application Publication
(10) Pub. No.: US 2021/0116331 A1
(43) Pub. Date: Apr. 22, 2021

(54) ANOMALY ANALYSIS METHOD, PROGRAM, AND SYSTEM

(71) Applicant: NEC CORPORATION, Minato-ku, Tokyo (JP)

(72) Inventor: Takazumi KAWAI, Tokyo (JP)

(73) Assignee: NEC Corporation, Minato-ku, Tokyo (JP)

(21) Appl. No.: 16/463,433

(22) PCT Filed: Dec. 8, 2016
(86) PCT No.: PCT/JP2016/005084

§ 371 Date: May 23, 2019

(51) Int. Cl. G01M 99/00; G06F 16/23

(52) U.S. Cl. CPC G01M 99/00; G06F 16/2358

(57) ABSTRACT

The present invention provides an anomaly analysis method, an anomaly analysis program, and an anomaly analysis system that display an anomaly degree for each group of sensors in a plurality of hierarchies and facilitate the determination of the factor of an anomaly. An anomaly analysis system according to an example embodiment of the present invention has: a group generation unit that generates a group of sensors for each hierarchy of a plurality of hierarchies; a group anomaly degree calculation unit that calculates a group anomaly degree for each group from measurement values of the sensors included in the group; and a display control unit that performs control of displaying a time-series change of the group anomaly degree in any hierarchy of the plurality of hierarchies.

### TECHNICAL FIELD

The present invention relates to an anomaly analysis method, an anomaly analysis program, and an anomaly analysis system that analyze an anomaly by using measurement values of sensors.

### BACKGROUND ART

In factory (plant) facilities, various types of sensors used for measuring a temperature, a pressure, a flowrate, or the like are provided at various positions, and the measurement values of the sensors are monitored by a monitoring system. When a sensor detects an anomaly measurement value, it is necessary to analyze the factor of the anomaly without delay and solve the factor. Since a plurality of sensors often output anomaly measurement values during a time period in which an anomaly occurs, in general, it may be difficult to identify a true factor of the anomaly.

In a technology disclosed in Patent Literature 1, a causal table representing a symptomatic pattern of an assumed anomaly is held for each system or subsystem of the plant, and a symptomatic pattern determined from the measurement value is compared to the causal table. Such a configuration enables identification of the anomaly source and the propagation path of the anomaly even when a large number of sensors are present.

### CITATION LIST

### Patent Literature

PTL 1: Japanese Patent Application Laid-Open No. H8-234832

### SUMMARY OF INVENTION

### Technical Problem

In the technology disclosed in Patent Literature 1, however, since the symptomatic pattern of an anomaly is determined for each plant system or subsystem, it is not possible to divide the system or subsystem into more detailed groups to analyze the factor of the anomaly. That is, even when the anomaly source and the propagation path of the anomaly can be identified in a system or a subsystem, it is not possible to analyze which position in each system or subsystem the true factor of the anomaly exists.

The present invention has been made in view of the problems described above and intends to provide an anomaly analysis method, an anomaly analysis program, and an anomaly analysis system that display the anomaly degree for each sensor group in a plurality of hierarchies and facilitate the determination of the factor of an anomaly.

A first example aspect of the present invention is an anomaly analysis method having steps of: generating at least one group of sensors for each hierarchy of a plurality of hierarchies; calculating a group anomaly degree on the group basis from measurement values of the sensors included in the group; and performing control of displaying a time-series change of the group anomaly degree in any one hierarchy of the plurality of hierarchies.

A second example aspect of the present invention is an anomaly analysis program that causes a computer to perform steps of: generating at least one group of sensors for each hierarchy of a plurality of hierarchies; calculating a group anomaly degree on the group basis from measurement values of the sensors included in the group; and performing control of displaying a time-series change of the group anomaly degree in any one hierarchy of the plurality of hierarchies.

A third example aspect of the present invention is an anomaly analysis system including: a group generation unit that generates at least one group of sensors for each hierarchy of a plurality of hierarchies; a group anomaly degree calculation unit that calculates a group anomaly degree on the group basis from measurement values of the sensors included in the group; and a display control unit that performs control of displaying a time-series change of the group anomaly degree in any one hierarchy of the plurality of hierarchies.

According to the present invention, since groups of sensors are formed for each hierarchy in a plurality of hierarchies and the anomaly degree of the group is displayed in time series for each hierarchy, the order of groups in which the anomaly degree increases can be analyzed in each hierarchy in which a criterion for grouping is different. Therefore, determination of what group has the factor of the anomaly becomes easier.

### BRIEF DESCRIPTION OF DRAWINGS

FIG. 1 is a diagram illustrating an exemplary graph of the number of abnormal sensors and an anomaly degree.

FIG. 2 is a block diagram of an anomaly analysis system according to a first example embodiment.

FIG. 3 is a schematic diagram illustrating a grouping method of sensors according to the first example embodiment.

FIG. 4 is a diagram illustrating a graph of the anomaly degree of groups in an approximate hierarchy displayed by the anomaly analysis system according to the first example embodiment.

FIG. 5 is a diagram illustrating a graph of the anomaly degree of the groups in a detail hierarchy displayed by the anomaly analysis system according to the first example embodiment.

FIG. 6 is a diagram illustrating a graph of the anomaly degree of the groups in a detail hierarchy displayed by the anomaly analysis system according to the first example embodiment.

FIG. 7 is a diagram of a general configuration of the anomaly analysis system according to the first example embodiment.

FIG. 8 is a diagram illustrating a flowchart of an anomaly analysis method according to the first example embodiment.

FIG. 9 is a schematic diagram illustrating a grouping method of sensors according to a second example embodiment.

FIG. 10 is a block diagram of an anomaly analysis system according to a third example embodiment.

FIG. 11 is a block diagram of an anomaly analysis system according to each example embodiment.

### DESCRIPTION OF EMBODIMENTS

While example embodiments of the present invention will be described below with reference to the drawings, the present invention is not limited to the present example embodiments. Note that, in the drawings described below, components having the same function are labeled with the same reference symbols, and the duplicated description thereof may be omitted.

### First Example Embodiment

Conventionally, a large number of sensors are provided in a factory (plant), a measurement value of the sensor is monitored by a monitoring system, and an anomaly is detected based on the measurement value of the sensor. Since a change of a measurement value of each sensor is small, it may be difficult to accurately detect the anomaly from the measurement value of each sensor. Accordingly, for example, there is a technology to determine whether the measurement value is normal or abnormal in accordance with whether or not the measurement value of the sensor is included in a predetermined normal range (for example, a range greater than or equal to the lower limit threshold and less than or equal to the upper limit threshold) and detect occurrence of an anomaly based on the total number of sensors indicating the abnormal measurement value. Similarly, there is a technology to calculate an anomaly degree (also referred to as an anomaly score) that indicates the degree of an anomaly from the measurement value and detect occurrence of an anomaly based on the total value of the anomaly degree.

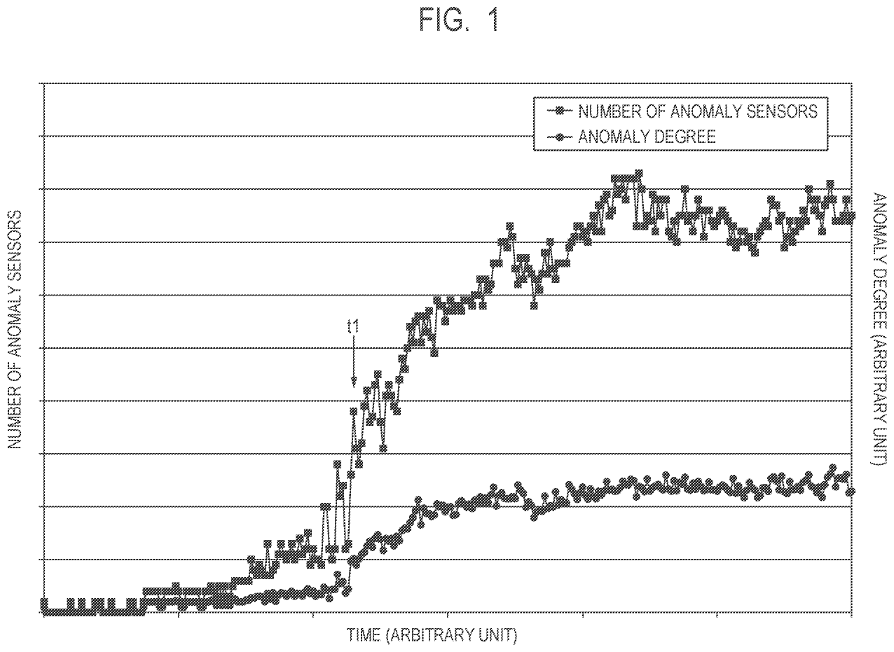

FIG. 1 is a diagram illustrating an exemplary graph of the number of abnormal sensors and the anomaly degree. The horizontal axis of the graph of FIG. 1 represents time (arbitrary unit), and the vertical axis represents the number of abnormal sensors or the anomaly degree (arbitrary unit). The number of the abnormal sensors is the total number of sensors indicating an anomaly measurement value at the time of interest. The anomaly degree is the total value of anomaly degrees of all the sensors (or sensors indicating anomaly measurement values) at that time. The graph of FIG. 1 indicates that the number of abnormal sensors and the anomaly degree sharply increase at time t1. Therefore, it can be determined that some anomaly occurred at the time 1, but it cannot be determined from the graph of FIG. 1 what has occurred or what the factor is.

In contrast, in the present example embodiment, groups of sensors are generated in a plurality of hierarchies, respectively, based on a predetermined criterion as described below, and the anomaly degree calculated for each group is displayed in time series in each hierarchy. With such a configuration, it is possible to recognize in what type of group of the sensors the anomaly occurred, which makes it easier to determine the factor of the anomaly. Further, since the time-series change of the anomaly degree can be switched and viewed from an approximate hierarchy (for example, the entire apparatus) to a detail hierarchy (for example, the position in the apparatus), the mechanism of anomaly occurrence can be analyzed in a detail unit.

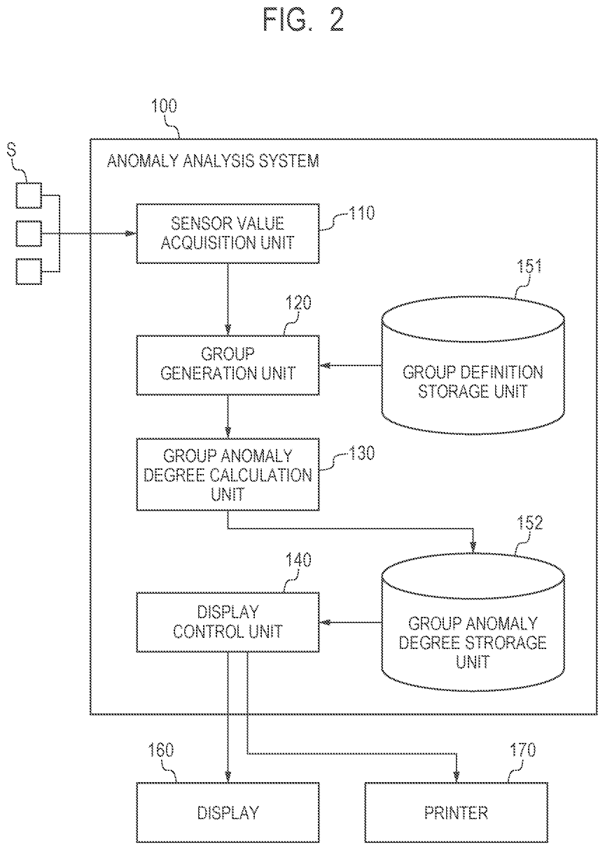

FIG. 2 is a block diagram of an anomaly analysis system 100 according to the present example embodiment. In FIG. 2, arrows represent main dataflows, and there may be other dataflows than those illustrated in FIG. 2. In FIG. 2, each block illustrates a configuration in a unit of function rather than in a unit of hardware (device). Therefore, the block illustrated in FIG. 2 may be implemented in a single device or may be implemented separately in a plurality of devices. Transmission and reception of the data between blocks may be performed via any member, such as a data bus, a network, a portable storage medium, or the like.

The anomaly analysis system 100 has a sensor value acquisition unit 110, a group generation unit 120, a group anomaly degree calculation unit 130, and a display control unit 140 as processing units. Further, the anomaly analysis system 100 has a group definition storage unit 151 and a group anomaly degree storage unit 152 as storage units. Further, the anomaly analysis system 100 is connected to a display 160 as a display device and a printer 170 as a display device.

The sensor value acquisition unit 110 acquires information indicating time-series measurement values (sensor values) measured by a plurality of sensors S provided in a factory (plant) to be analyzed. The sensor value acquisition unit 110 may sequentially receive the sensor value from the sensor S or collectively receive the sensor values for a predetermined time period. Further, the sensor value acquisition unit 110 may read the sensor value that has been received in advance from the sensor S and stored in the anomaly analysis system 100. The sensor S may be any sensor such as a temperature sensor, a pressure sensor, a flowrate sensor, an air volume sensor, or the like. The sensors S may include one or multiple types of sensors, and the same type of sensors may be provided at a plurality of places. Each sensor S is identified and managed in accordance with the type and the installation place.

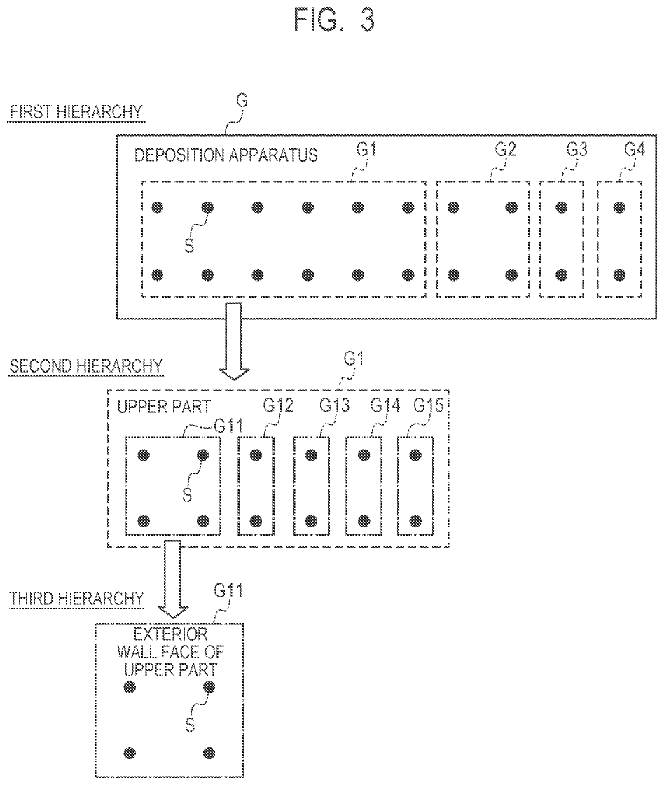

The group generation unit 120 generates a group for each hierarchy by classifying the sensors S in which the sensor values are acquired by the sensor value acquisition unit 110 in a plurality of hierarchies, respectively. A grouping method of the sensors S by the anomaly analysis system 100 according to the present example embodiment will be described by using FIG. 3.

FIG. 3 is a schematic diagram illustrating a grouping method of the sensors S according to the present example embodiment. The group generation unit 120 classifies the plurality of sensors S in which the sensor values are acquired by the sensor value acquisition unit 110 on a plurality of hierarchies, respectively, and generates a group for each hierarchy. A plurality of hierarchies are hierarchies having different criteria (granularities) for grouping of the sensors S. That is, a plurality of hierarchies include relatively approximate hierarchies and relatively detail hierarchies. In an approximate hierarchy, the range of grouping is wider and the number of sensors S included in one group is greater than those of a detail hierarchy.

The plurality of exemplary hierarchies illustrated in FIG. 3 include a first hierarchy in which the sensors S are grouped in the entire apparatus, a second hierarchy in which the sensors S are grouped for each position in the apparatus, and a third hierarchy in which the sensors S are grouped for each more detailed position in the apparatus. That is, the group generation unit 120 defines a plurality of hierarchies in which grouping is performed in accordance with different criteria such as a position in the apparatus and a portion in which the position is further divided and classifies the sensors S (for example, provided at a predetermined position) into the same groups based on a predetermined criterion in each hierarchy.

Specifically, in the first hierarchy, the group generation unit 120 generates a group G formed of the sensors S provided in a film formation apparatus. A group of washing devices, a group of cooling devices, a group of heating devices, or the like (not illustrated) may be included in the same first hierarchy in addition to the group G of the film formation apparatus. The group G of the film formation apparatus in the first hierarchy is divided into smaller groups G1 to G4 in the second hierarchy.

Next, in the second hierarchy, the group generation unit 120 generates the group G1 formed of the sensors S provided to the upper part of the film formation apparatus. Groups G2 to G4 such as the lower part, the side part, or the like may be included in the same second hierarchy in addition to the group G1. The group G1 of the upper part in the second hierarchy is divided into further smaller groups G11 to G15 in the third hierarchy.

Next, in the third hierarchy, the group generation unit 120 generates the group G11 formed of the sensors S provided on an exterior wall face of the upper part of the film formation apparatus. Groups G12 to G15 such as the inner wall face of the upper part, the space in the upper part, or the like may be included in the same third hierarchy in addition to the group G11 of the exterior wall face of the upper part. The group G11 in the third hierarchy may be divided into further detail groups of sensors in the additional hierarchies.

While the groups are generated based on the domain knowledge of the facility and the position or the like thereof in FIG. 3, the criterion for grouping is not limited thereto as long as a group indicating the relationship of the plurality of sensors S can be generated. By grouping the sensors S on a system basis, for example, anomaly analysis can be performed across facilities. Further, by grouping the sensors S for each unit to be replaced at the time of a failure, it is possible to easily determine the unit to be replaced as a factor of the anomaly. Further, grouping of the sensors S may be performed on a name (type) of the sensor basis, or grouping by using a relative relationship between the sensors S may also be performed as described in a second example embodiment.

While a sensor S belongs to a single group in one hierarchy in FIG. 3, a sensor S may belong to a plurality of groups in one hierarchy. In other words, groups are not exclusive to each other and may overlap each other. The number of hierarchies and the number of criteria are not limited to those illustrated here, and any criterion that can group the sensors S in accordance with different granularities can be used.

In the group definition storage unit 151, group definition information that indicates a criterion used for grouping the sensors S is pre-stored. The group definition information includes information that defines how to classify the plurality of sensors S to generate a group in a plurality of hierarchies in order to generate the groups according to the present example embodiment. The group generation unit 120 reads the group definition information stored in the group definition storage unit 151 and generates groups in a plurality of hierarchies in accordance with the group definition information as described above.

For example, group definition information includes information on a facility and a position therein that are used as criteria for classification in each hierarchy. In such a case, in accordance with the facility and the position therein where the sensors S are actually provided, the group generation unit 120 generates groups for each facility and each of the positions therein as illustrated in FIG. 3. Group definition information may include not only information described above but also information necessary to perform an actual grouping method.

Group definition information may be expressed in any data format (file format) and may be binary data or text data, for example. Further, group definition information may be stored in the group definition storage unit 151 as a binary file or a text file or may be stored in the group definition storage unit 151 as a database table.

The group anomaly degree calculation unit 130 calculates a group anomaly degree in time series for each group in each hierarchy generated by the group generation unit 120 and stores the calculated group anomaly degree in the group anomaly degree storage unit 152. The group anomaly degree is the total value of anomaly degrees of the sensors S included in the group at a certain time. The anomaly degree of the sensor S is a differential value (or a ratio) between a measurement value of the sensor S and a predetermined threshold, for example. Further, the group anomaly degree is not limited to the total value of the anomaly degrees of the sensors S and may be the number of sensors S having the anomaly degree greater than or equal to the predetermined threshold. Further, the group anomaly degree may be the value normalized by dividing the total value of anomaly degrees of the sensors S included in a group by the number of the sensors S included in the group of interest.

The group anomaly degree may be expressed in any data format (file format) and may be binary data or text data, for example. Further, the group anomaly degree may be stored in the group anomaly degree storage unit 152 as a binary file or a text file or may be stored in the group anomaly degree storage unit 152 as a database table.

The anomaly degree of the sensor S is not limited to the value illustrated here, and any value that can indicate the degree to which the measurement value of the sensor S deviates from the normal range may be used. Further, the group anomaly degree may be a value obtained by performing invariant analysis on the correlation between two sensors S as described in the second example embodiment, defining a difference between an estimation value by the correlation model and the measurement value of the sensor S (that is, a prediction error) as the anomaly degree, and summing the anomaly degrees of all the combinations of two sensors S included in the group.

When different types of sensors S such as a temperature sensor, a pressure sensor, or the like are present, the anomaly degree may be multiplied by a coefficient determined for each type so as to absorb the difference in the type of the sensor S. The coefficient for each type of the sensor S may be stored in the group definition storage unit 151 together with group definition information.

The sensor S may be weighted, and a weight coefficient set for each sensor S may be multiplied by the anomaly degree of the sensor S. With a large weight coefficient being set for an important sensor S, the anomaly occurred in the important sensor S is likely to be reflected in the group anomaly degree. The weight coefficient may be stored in the group definition storage unit 151 together with the group definition information.

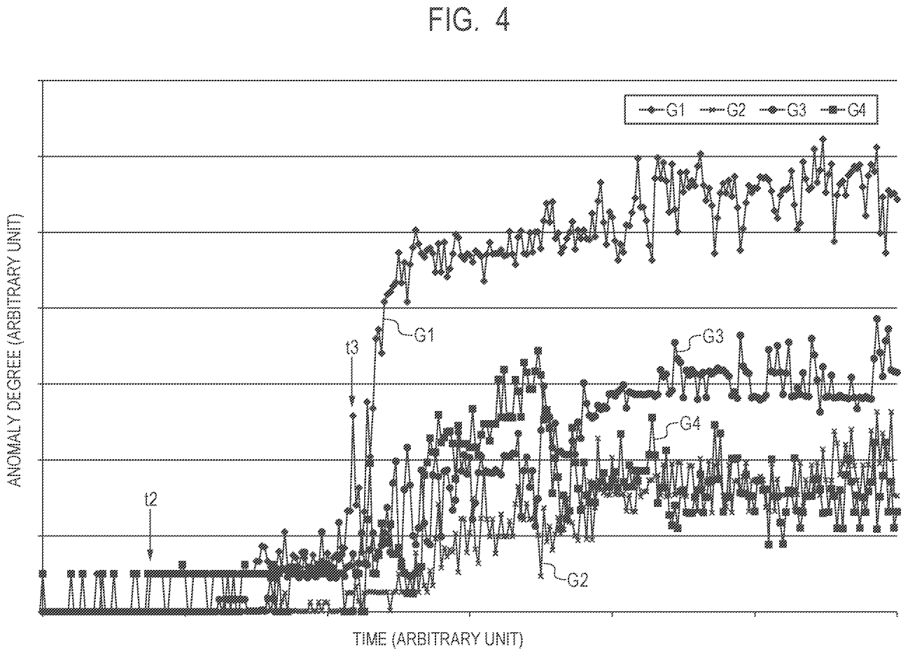

The display control unit 140 performs control to display the group anomaly degree calculated by the group anomaly degree calculation unit 130 and stored in the group anomaly degree storage unit 152 in time series for each hierarchy. In the present example embodiment, the term of display refers to providing visually indication to a user, such as display by the display 160, printing by the printer 170, or the like. A display method of the group anomaly degree by the anomaly analysis system 100 according to the present example embodiment will be described by using FIG. 4 to FIG. 6.

FIG. 4 is a diagram illustrating a graph of the group anomaly degrees in an approximate hierarchy displayed by the anomaly analysis system 100 according to the present example embodiment. Since an approximate hierarchy is a relative meaning, the first hierarchy and the second hierarchy are approximate hierarchies relative to the third hierarchy, and the first hierarchy is an approximate hierarchy relative to the second hierarchy in the example in FIG. 3. The horizontal axis of the graph in FIG. 4 represents time (arbitrary unit), and the vertical axis represents the group anomaly degree (arbitrary unit) calculated by the group anomaly degree calculation unit 130. In response to accepting a predetermined operation from a user, the anomaly analysis system 100 displays the graph in FIG. 4 via the display 160 or the printer 170.

The graph in FIG. 4 illustrates time-series changes of the group anomaly degree of the groups G1 to G4 in the second hierarchy in FIG. 3. It can be seen from the graph in FIG. 4 that the group anomaly degrees of the groups G1 and G4 intermittently increase and decrease until time t2. It can be seen that the group anomaly degree of the group G1 then starts increasing at the time t2 and further increases sharply at time t3. After the increase of the group anomaly degree of the group G1, the group anomaly degrees of the groups G3 and G4 increase, and then the group anomaly degree of the group G2 increases. Therefore, it can be estimated from the graph in FIG. 4 that some anomaly factor occurred at the time t2 at a position in the facility where the sensor S belonging to the group G1 is provided and the influence thereof propagates to the groups G2 to G4.

While the group anomaly degree of the group G1 exhibits a two-step increase at the time t2 and t3, analysis of the factor of the anomaly cannot be performed in more detail with the graph of the second hierarchy. Accordingly, when only receiving a predetermined operation (for example, an operation of specifying the group G1 by an input device) by the user, the anomaly analysis system 100 displays a graph of the group anomaly degree of a more detailed hierarchy (the third hierarchy in this example) via the display 160 or the printer 170.

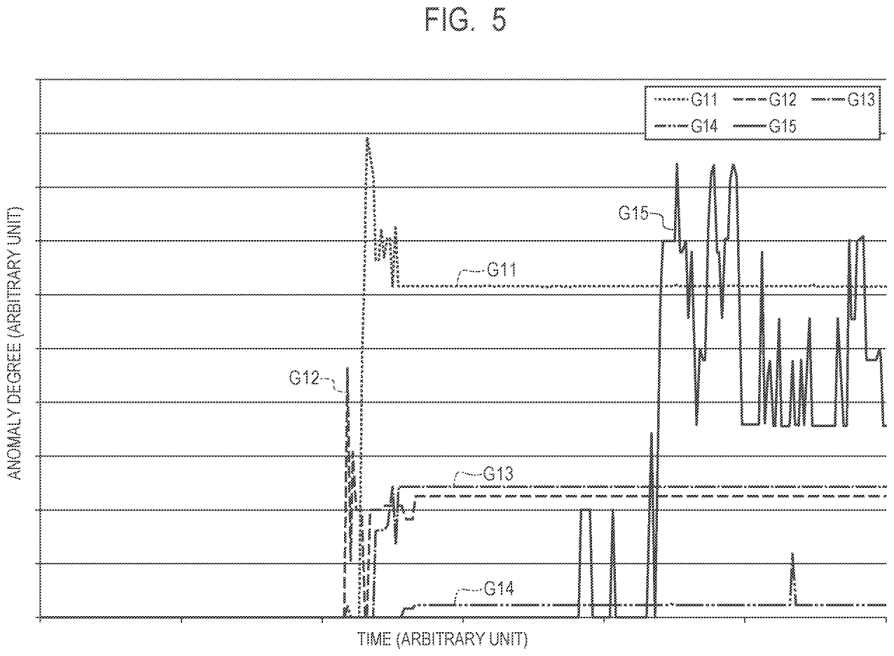

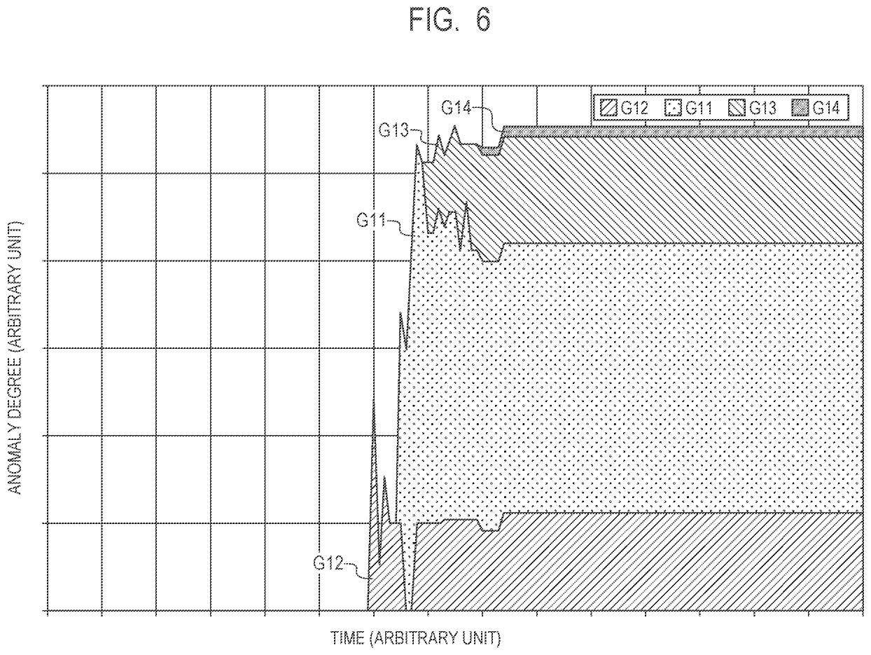

FIG. 5 and FIG. 6 are diagrams illustrating graphs of the group anomaly degrees in a detail hierarchy displayed by the anomaly analysis system 100 according to the present example embodiment. Since a detail hierarchy is a relative meaning, the second hierarchy and the third hierarchy are detail hierarchies relative to the first hierarchy, and the third hierarchy is a detail hierarchy relative to the second hierarchy in the example in FIG. 3. The horizontal axis of each graph in FIG. 5 and FIG. 6 represents time (arbitrary unit), and the vertical axis represents the group anomaly degree (arbitrary unit) calculated by the group anomaly degree calculation unit 130.

The graph in FIG. 5 illustrates time-series changes of the group anomaly degree of the groups G11 to G15 in the third hierarchy in FIG. 3 by using a line graph, respectively. That is, the graph of the groups G11 to G15 in FIG. 5 is a close-up representation of the graph of the group G1 in FIG. 4 to a more detailed hierarchy. It can be seen from the graph in FIG. 5 that the group anomaly degree of the group G12 initially increases, the influence thereof propagates to the group G11, and the group anomaly degree of the group G12 is once suppressed. It can be seen that the group anomaly degree of the group G12 then increases again, and the group anomaly degrees of G13, G14, and G15 sequentially increase. Therefore, it can be estimated from the graph in FIG. 5 that a position in the facility where the sensor S belonging to the group G11 causes the factor of the anomaly, and the influence thereof sequentially propagates to groups G11, G13, G14, and G15.

The graph in FIG. 6 illustrates time-series changes of the group anomaly degree of the groups G11 to G14 (group G15 is omitted) in the third hierarchy in FIG. 3 by using a stacked graph. The stacked graph uses a value obtained by adding the values of the group anomaly degree of each group G11 to G14 to the vertical axis direction in the line graph. In the example in FIG. 6, the group anomaly degree itself of the group G12 is used as the value of the group G12 on the vertical axis, the total value of the group anomaly degrees of the groups G11 and G12 is used as the value of the group G11 on the vertical axis, the total value of the group anomaly degrees of the groups G11 to G13 is used as the value of the group G13 on the vertical axis, and the total value of the group anomaly degrees of the groups G11 to G14 is used as the value of the group G14 on the vertical axis.

From the stacked graph in FIG. 6, a factor of the anomaly and propagation of the influence of the anomaly can be analyzed, and the change of the group anomaly degree as a whole can be easily known as with the line graph in FIG. 5.

The anomaly analysis system 100 may display either the line graph in FIG. 5 or the stacked graph in FIG. 6 or may switch and display the graphs in response to a predetermined operation by the user.

The display method of the group anomaly degree illustrated in FIG. 4 to FIG. 6 is an example, and any display method such as a line graph, a bar graph, an area graph, or the like may be used as long as a time-series change of the group anomaly degree for each group can be indicated to the user.

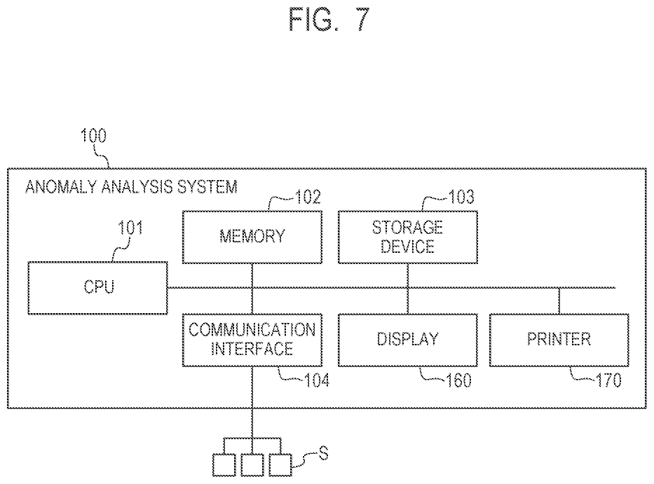

FIG. 7 is a general configuration diagram illustrating an exemplary device configuration of the anomaly analysis system 100 according to the present example embodiment. The anomaly analysis system 100 has a central processing unit (CPU) 101, a memory 102, a storage device 103, a communication interface 104, the display 160, and the printer 170. The anomaly analysis system 100 may be an independent apparatus or may be configured integrally with another apparatus.

The communication interface 104 is a communication unit that transmits and receives data and is configured to be able to execute at least one of the communication schemes of wired communication and wireless communication. The communication interface 104 includes a processor, an electric circuit, an antenna, a connection terminal, or the like required for the above communication scheme. The communication interface 104 performs communication by using the communication scheme in accordance with a signal from the CPU 101. The communication interface 104 receives information that indicates the measurement value of the sensor S from the sensor S, for example.

The storage device 103 stores a program executed by the anomaly analysis system 100, data of a process result obtained by the program, or the like. The storage device 103 includes a read only memory (ROM) dedicated to reading, a hard disk drive or a flash memory that is readable and writable, or the like. Further, the storage device 103 may include a computer readable portable storage medium such as a CD-ROM. The memory 102 includes a random access memory (RAM) or the like that temporarily stores data being processed by the CPU 101 or a program and data read from the storage device 103.

The CPU 101 is a processor as a processing unit that temporarily stores temporary data used for processing in the memory 102, reads a program stored in the storage device 103, and executes various processing operations such as calculation, control, determination, or the like on the temporary data in accordance with the program. Further, the CPU 101 stores data of a process result in the storage device 103 and also transmits data of the process result externally via the communication interface 104.

In the present example embodiment, the CPU 101 functions as the sensor value acquisition unit 110, the group generation unit 120, the group anomaly degree calculation unit 130, and the display control unit 140 of FIG. 2 by executing the program stored in the storage device 103. Further, in the present example embodiment, the storage device 103 functions as the group definition storage unit 151 and the group anomaly degree storage unit 152 of FIG. 2.

The display 160 is a display device that displays information to the user. Any display device such as a cathode ray tube (CRT) display, a liquid crystal display, or the like may be used as the display 160. The display 110 displays predetermined information such as process display information in accordance with a signal from the CPU 101.

The printer 170 is a printer device that prints predetermined information such as process display information or the like in accordance with a signal from the CPU 101. Any printer device such as a thermal printer, an ink jet printer, a laser printer, or the like may be used as the printer 170.

The anomaly analysis system 100 is not limited to the specific configuration illustrated in FIG. 7. The anomaly analysis system 100 is not limited to a single device and may be configured such that two or more physically separated devices are connected by wired or wireless connection. Respective units included in the anomaly analysis system 100 may be implemented by an electric circuitry, respectively. The electric circuitry here is a term conceptually including a single device, multiple devices, a chipset, or a cloud.

Further, at least a part of the anomaly analysis system 100 may be provided as a form of Software as a Service (SaaS). That is, at least some of the functions for implementing the anomaly analysis system 100 may be executed by software executed via a network.

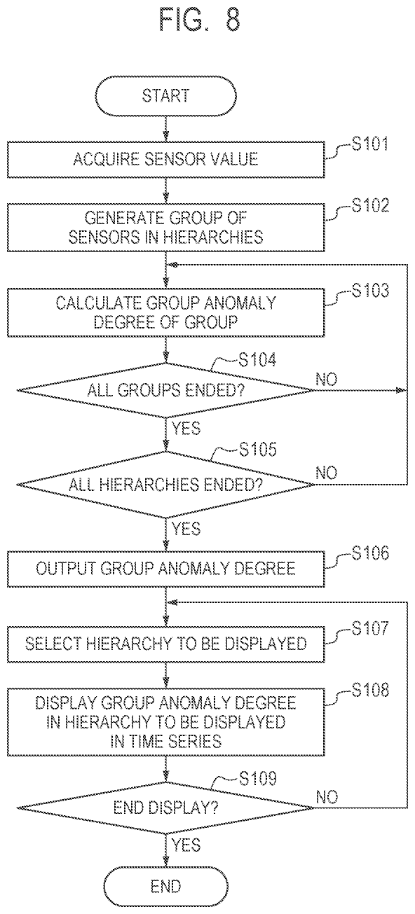

FIG. 8 is a diagram illustrating a flowchart of the anomaly analysis method using the anomaly analysis system 100 according to the present example embodiment. The anomaly analysis method is started by a user performing a predetermined operation on the anomaly analysis system 100, for example.

First, the sensor value acquisition unit 110 acquires information that indicates a time-series measurement value (sensor value) measured by a plurality of sensors S provided in the factory (plant) to be analyzed (step S101). The sensor value acquisition unit 110 may acquire a sensor value from a sensor S via the communication interface 104 or may acquire a sensor value by reading the sensor value that has already been acquired from the sensor S and stored in the memory 102 or the storage device 103 of the anomaly analysis system 100.

Next, the group generation unit 120 generates a group by classifying the sensors S in which the sensor value is acquired in step S101 on a plurality of hierarchies, respectively (step S102). More specifically, the group generation unit 120 reads group definition information indicating a criterion used for grouping the sensors S from the group definition storage unit 151. The group generation unit 120 then determines a plurality of hierarchies in which the groups are to be generated (for example, the first hierarchy to the third hierarchy in FIG. 3) based on the group definition information and generates groups by classifying the sensors S for each hierarchy.

Next, in one hierarchy of the plurality of hierarchies generated in step S102, the group anomaly degree calculation unit 130 calculates the group anomaly degree of one group of the plurality of groups in time series (step S103). As a group anomaly degree, a value calculated by using the total value of the anomaly degrees of the sensors S included in the group, the number of the sensors S having the anomaly degree greater than or equal to the predetermined threshold, or the like is used.

If the calculation of the group anomaly degree is not finished for all the groups in the target hierarchy (step S104, NO), step S103 is repeated for the next group. If the calculation of the group anomaly degree is finished for all the groups in the target hierarchy (step S104, YES), the process proceeds to step S105.

If the group anomaly degree is not calculated for all the hierarchies determined in step S102 (step S105, NO), step S103 is repeated for the next hierarchy. If the group anomaly degree is calculated for all the hierarchies determined in step S102 (step S105, YES), the process proceeds to step S106.

The group anomaly degree calculation unit 130 outputs the group anomaly degree calculated for each hierarchy and each group in step S103 (step S106). The output group anomaly degree is stored in the group anomaly degree storage unit 152.

The display control unit 140 selects a hierarchy to be displayed out of the plurality of hierarchies determined in step S102 (step S107). The hierarchy to be displayed may be specified in advance by the anomaly analysis system 100 or may be specified in accordance with a predetermined operation by the user.

The display control unit 140 performs control of displaying the group anomaly degree of each group included in the hierarchy to be displayed selected in step S107 as a time-series graph (step S108). The display control unit 140 displays the group anomaly degree by controlling the display 160 or the printer 170. The group anomaly degree is represented in time series by a line graph illustrated in FIG. 4 and FIG. 5 or by a stacked graph illustrated in FIG. 6, for example.

If the display is not finished in such a case where display of another hierarchy is instructed by the user (step S109, NO), steps S107 to S108 are repeated for the hierarchy to be displayed. If the display is finished in such a case where the end of display is instructed by the user (step S109, YES), the anomaly analysis method ends.

While the calculation process of the group anomaly degree in steps S101 to S106 and the display process of the group anomaly degree in steps S107 to S109 are sequentially performed in the flowchart in FIG. 8, these processes may be individually performed. The calculation process of the group anomaly degree may be performed as a batch process automatically performed in a predetermined time interval, and the display process of the group anomaly degree may be performed as an interactive process performed in response to an operation by the user, for example.

The CPU 101 of the anomaly analysis system 100 in the present example embodiment is the subject of each step (process) included in the processes illustrated in FIG. 8. That is, the CPU 101 reads a program used for executing the processes illustrated in FIG. 8 from the memory 102 or the storage device 103 and performs the processes illustrated in FIG. 8 by executing the program and controlling each unit of the anomaly analysis system 100. Further, at least of some of the processes illustrated in FIG. 8 may be performed not by the CPU 101 but by a dedicated device or a dedicated electric circuit.

The anomaly analysis method using the anomaly analysis system 100 according to the present example embodiment generates groups of the sensors S in a plurality of hierarchies in which the criteria used for grouping are different, respectively, and displays a time-series change of the group anomaly degree for each hierarchy. Therefore, the user can recognize a time-series perspective of the anomaly degree and can analyze the position corresponding to a factor of an anomaly, the propagation of the influence of the anomaly, and the occurrence mechanism of the anomaly in detail with reference to the close-up graph of the more detail hierarchy (position).

### Second Example Embodiment

While a hierarchy and a group are defined based on an apparatus and a position therein on which the sensors S are installed in the first example embodiment, a hierarchy and a group are defined based on a correlation between the sensors S in the present example embodiment. In the present example embodiment, only the criterion for grouping is different from that of the first example embodiment, and the anomaly analysis system 100 having the same configuration as that of the first example embodiment is used.

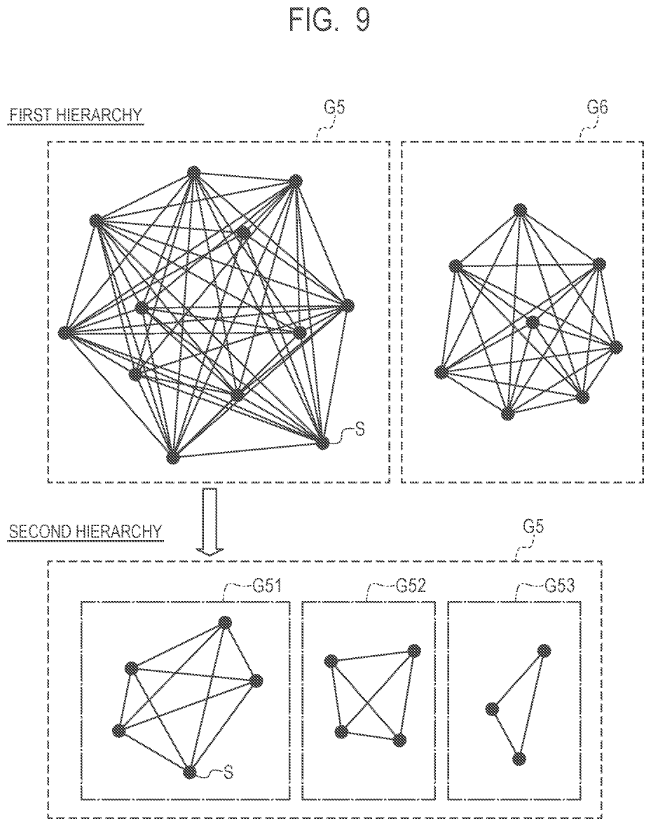

FIG. 9 is a schematic diagram illustrating a grouping method of the sensors S according to the present example embodiment. In the present example embodiment, the group generation unit 120 calculates a correlation value between the sensors S in which the sensor value is acquired by the sensor value acquisition unit 110 by using an invariant model, that is, an Auto-Regressive with eXogenous input (ARX) model, for example. In the invariant model, anomaly analysis can be performed by defining a relationship at a normal state (invariant relationship) between the variables (here, between two sensors S) as a model and comparing the model with the measurement value. A higher correlation between the two sensors S causes a larger correlation value in the model.

The group generation unit 120 classifies a plurality of sensors S on a plurality of hierarchies, respectively, based on the calculated correlation value between the sensors S and generates groups for each hierarchy. While two hierarchies of a first hierarchy and a second hierarchy are used here, the number of hierarchies is not limited thereto.

Specifically, the group generation unit 120 generates groups G5 and G6 formed of a set of sensors S having a correlation value greater than or equal to a first threshold in the first hierarchy. The first threshold is set to a relatively small value, and the sensors S having a relatively low correlation are grouped. Therefore, large groups G5 and G6 (that is, the number of sensors S included is large) are generated in the first hierarchy.

Next, with respect to the group G5, the group generation unit 120 generates groups G51 to G53 formed of a set of sensors S having a correlation value greater than or equal to a second threshold in the second hierarchy. The second threshold is set larger than the first threshold, and the sensors S having a higher correlation are grouped. Therefore, smaller groups than that in the first hierarchy (that is, the number of sensors S included is small) are generated in the second hierarchy. Similarly, groups (not illustrated) are generated in the second hierarchy also in the group G6.

The group anomaly degree calculation unit 130 defines a difference between the measurement value of each sensor S included in a group and an estimated value in the model (that is, a prediction error) as an anomaly degree of the sensor S and calculates the sum of the anomaly degrees as a group anomaly degree of the group. Another definition may be used as the group anomaly degree. For example, an anomaly degree in which a sensor S is weighted based on the prediction error and the weight for each sensor S is reflected may be used.

The anomaly analysis system 100 according to the present example embodiment has the same advantage as that of the first example embodiment, and since a hierarchy and a group are defined by using a correlation between the sensors S, groups can be generated in a plurality of hierarchies without presetting criteria for hierarchies and groups by using the domain knowledge of an apparatus and a position therein.

### Third Example Embodiment

While a time-series change of the group anomaly degree is displayed in the first example embodiment, the occurrence process of the anomaly is further learned and anomaly detection is performed in the present example embodiment. A part different from the first example embodiment will be described below.

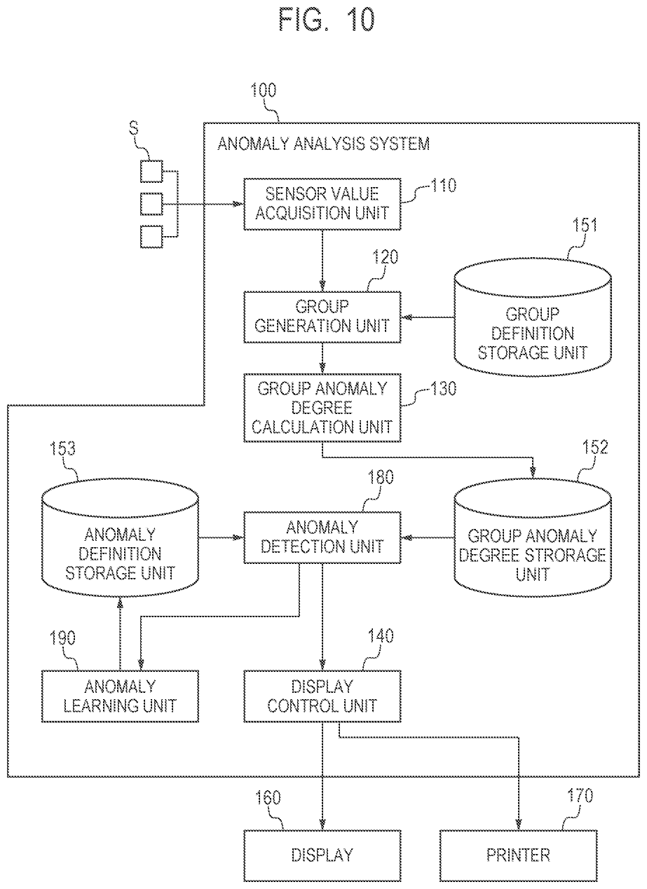

FIG. 10 is a block diagram of an anomaly analysis system 100 according to the present example embodiment. The arrows indicate a main flow of data, and there may be a flow of data other than those illustrated in FIG. 10. Each block does not indicate a configuration of a unit of hardware (device) but indicates a configuration of a unit of the function in FIG. 10. Therefore, the block illustrated in FIG. 10 may be implemented in a single device or may be separately implemented in a plurality of devices. The transmission and reception of data between blocks may be performed by any members such as a data bus, a network, a portable storage medium, or the like.

The anomaly analysis system 100 in FIG. 10 has an anomaly detection unit 180 and an anomaly learning unit 190 as a processing unit and an anomaly definition storage unit 153 as a storage unit in addition to the configuration in FIG. 2.

The anomaly detection unit 180 detects an anomaly from a time-series change of the group anomaly degree based on anomaly definition information stored in the anomaly definition storage unit 153. In the anomaly definition storage unit 153, anomaly definition information that indicates a pattern of the order in which the group anomaly degrees increase when an anomaly occurs is stored. The anomaly detection unit 180 reads the anomaly definition information stored in the anomaly definition storage unit 153 and detects an anomaly in accordance with the anomaly definition information. The anomaly detection unit 180 may detect an anomaly sign from the time-series change of the group anomaly degree currently output or may detect an anomaly after the occurrence from the time-series change of the group anomaly degree output in the past.

Specifically, the anomaly detection unit 180 determines the order of the groups indicating the group anomaly degree greater than or equal to a predetermined threshold as a pattern. The order of the groups G12, G11, and G13 in FIG. 5 is determined as a pattern, for example. The anomaly detection unit 180 determines whether anomaly definition information that matches the determined pattern exists in the anomaly definition storage unit 153. When the anomaly definition information that matches the determined pattern exists, the anomaly detection unit 180 detects an anomaly, and the display control unit 140 notifies the user of the anomaly in accordance with the detection result. Thereby, the user can recognize that the same pattern of the group anomaly degree as that of the anomaly that occurred in the past is output.

Further, when the determined pattern matches at least an initial part of the pattern of the anomaly definition information stored in the anomaly definition storage unit 153, the anomaly detection unit 180 detects an anomaly sign, and the display control unit 140 may notify the user of the anomaly sign in accordance with the detection result. Thereby, the user can recognize the anomaly sign that occurred in the past and can address the anomaly beforehand.

The method of anomaly detection is not limited to that illustrated here. The pattern may be the order of combination of a plurality of groups indicating the group anomaly degrees greater than or equal to the predetermined threshold, for example.

For example, in FIG. 5, a pattern in the order of the group G12, the combination of the groups G11 and G12, and the combination of the groups G11 to G13 may be anomaly definition information.

When a pattern detected in a time-series change of the group anomaly degree does not match any of anomaly definition information stored in the anomaly definition storage unit 153, the anomaly learning unit 190 stores the pattern of interest in the anomaly definition storage unit 153 as new anomaly definition information. Thereby, an unknown group anomaly degree is registered and can be used for anomaly detection for the next time.

In the present example embodiment, the CPU 101 functions as the sensor value acquisition unit 110, the group generation unit 120, the group anomaly degree calculation unit 130, the display control unit 140, the anomaly detection unit 180, and the anomaly learning unit 190 of FIG. 10 by executing the program stored in the storage device 103. Further, in the present example embodiment, the storage device 103 functions as the group definition storage unit 151, the group anomaly degree storage unit 152, and the anomaly definition storage unit 153 of FIG. 10.

### Another Example Embodiment

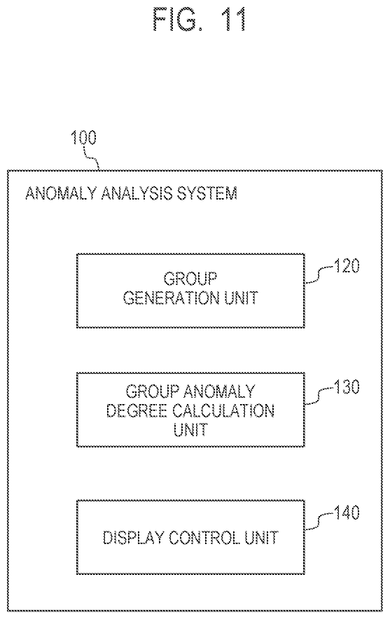

FIG. 11 is a block diagram of the anomaly analysis system 100 according to each example embodiment described above. FIG. 11 illustrates a configuration example by which the anomaly analysis system 100 functions as a device that generates groups of the sensors S in a plurality of hierarchies and displays the time-series change of the group anomaly degree. The anomaly analysis system 100 includes a group generation unit 120 that generates groups of sensors in a plurality of hierarchies, respectively, a group anomaly degree calculation unit 130 that calculates a group anomaly degree for each group by using measurement values of the sensors included in the group, and a display control unit 140 that performs control of displaying a time-series change of the group anomaly degree in any one hierarchy of the plurality of hierarchies.

The present invention is not limited to the example embodiments described above and can be properly changed within the scope not departing from the spirit of the present invention.

The scope of each of the example embodiments also includes a processing method that stores, in a storage medium, a program that causes the configuration of each of the example embodiments to operate so as to implement the function of each of the example embodiments described above (more specifically, an anomaly analysis program that causes a computer to perform the process illustrated in FIG. 8), reads the program stored in the storage medium as a code, and executes the program in a computer. That is, the scope of each of the example embodiments also includes a computer readable storage medium. Further, each of the example embodiments includes not only the storage medium in which the program described above is stored but also the program itself.

As the storage medium, for example, a floppy (registered trademark) disk, a hard disk, an optical disk, a magneto-optical disk, a CD-ROM, a magnetic tape, a nonvolatile memory card, or a ROM can be used. Further, the scope of each of the example embodiments includes an example that operates on OS to perform a process in cooperation with another software or a function of an add-in board without being limited to an example that performs a process by an individual program stored in the storage medium.

The whole or part of the example embodiments disclosed above can be described as, but not limited to, the following supplementary notes.

(Supplementary note 1)

An anomaly analysis method comprising steps of:

generating at least one group of sensors for each hierarchy of a plurality of hierarchies;

calculating a group anomaly degree on the group basis from measurement values of the sensors included in the group; and performing control of displaying a time-series change of the group anomaly degree in any one hierarchy of the plurality of hierarchies.

(Supplementary note 2)

The anomaly analysis method according to supplementary note 1, wherein the step of performing control performs control of displaying the time-series change of the group anomaly degree in a first hierarchy of the plurality of the hierarchies, and with respect to the group specified in the first hierarchy, then performs control of displaying the time-series change of the group anomaly degree in a second hierarchy of the plurality of hierarchies.

(Supplementary note 3)

The anomaly analysis method according to supplementary note 1 or 2, wherein the step of generating the group generates the group on the hierarchy basis in the plurality of hierarchies by classifying the sensors based on a position or a system in a facility at which the sensors are installed.

(Supplementary note 4)

The anomaly analysis method according to supplementary note 3, wherein the step of generating the group generates the group in a first hierarchy by classifying the sensors provided at a position or a system in a single facility and generates the group in a second hierarchy by classifying the sensors provided at a portion into which the position or the system is further divided.

(Supplementary note 5)

The anomaly analysis method according to supplementary note 1 or 2, wherein the step of generating the group generates the group by classifying the sensors based on a correlation between a pair of the sensors the number of which is two.

(Supplementary note 6) The anomaly analysis method according to supplementary note 5, wherein the step of generating the group generates the group in a first hierarchy by classifying the pair of the sensors having a correlation value greater than or equal to a first threshold and generates the group in a second hierarchy by classifying the pair of the sensors having the correlation value greater than or equal to a second threshold that is greater than the first threshold.

(Supplementary note 7)

The anomaly analysis method according to any one of supplementary notes 1 to 6, wherein the step of calculating the group anomaly degree calculates the group anomaly degree by using a value in which an anomaly degree for each of the sensors is summed or the number of the sensors indicating the anomaly degree that is greater than or equal to a predetermined threshold.

(Supplementary note 8) The anomaly analysis method according to any one of supplementary notes 1 to 6, wherein the step of calculating the group anomaly degree calculates the group anomaly degree by using a difference between an estimated value calculated from a correlation at a normal state of a pair of the sensors the number of which is two and a measurement value of the pair of the sensors.

(Supplementary note 9)

The anomaly analysis method according to any one of supplementary notes 1 to 8 further comprising a step of detecting anomaly based on in what order the group anomaly degree of the plurality of groups increases.

(Supplementary note 10)

An anomaly analysis program that causes a computer to perform steps of:

generating at least one group of sensors for each hierarchy of a plurality of hierarchies;

calculating a group anomaly degree on the group basis from measurement values of the sensors included in the group; and performing control of displaying a time-series change of the group anomaly degree in any one hierarchy of the plurality of hierarchies.

(Supplementary note 11)

An anomaly analysis system comprising:

a group generation unit that generates at least one group of sensors for each hierarchy of a plurality of hierarchies;

a group anomaly degree calculation unit that calculates a group anomaly degree on the group basis from measurement values of the sensors included in the group; and

a display control unit that performs control of displaying a time-series change of the group anomaly degree in any one hierarchy of the plurality of hierarchies.

What is claimed is:

1. An anomaly analysis method comprising steps of:
generating at least one group of sensors for each hierarchy of a plurality of hierarchies;
calculating a group anomaly degree on the group basis from measurement values of the sensors included in the group; and
performing control of displaying a time-series change of the group anomaly degree in any one hierarchy of the plurality of hierarchies.

2. The anomaly analysis method according to claim 1, wherein the step of performing control performs control of displaying the time-series change of the group anomaly degree in a first hierarchy of the plurality of the hierarchies, and with respect to the group specified in the first hierarchy, then performs control of displaying the time-series change of the group anomaly degree in a second hierarchy of the plurality of hierarchies.

3. The anomaly analysis method according to claim 1, wherein the step of generating the group generates the group on the hierarchy basis in the plurality of hierarchies by classifying the sensors based on a position or a system in a facility at which the sensors are installed.

4. The anomaly analysis method according to claim 3, wherein the step of generating the group generates the group in a first hierarchy by classifying the sensors provided at a position or a system in a single facility and generates the group in a second hierarchy by classifying the sensors provided at a portion into which the position or the system is further divided.

5. The anomaly analysis method according to claim 1, wherein the step of generating the group generates the group by classifying the sensors based on a correlation between a pair of the sensors the number of which is two.

6. The anomaly analysis method according to claim 5, wherein the step of generating the group generates the group in a first hierarchy by classifying the pair of the sensors having a correlation value greater than or equal to a first threshold and generates the group in a second hierarchy by classifying the pair of the sensors having the correlation value greater than or equal to a second threshold that is greater than the first threshold.

7. The anomaly analysis method according to claim 1, wherein the step of calculating the group anomaly degree calculates the group anomaly degree by using a value in which an anomaly degree for each of the sensors is summed or the number of the sensors indicating the anomaly degree that is greater than or equal to a predetermined threshold.

8. The anomaly analysis method according to claim 1, wherein the step of calculating the group anomaly degree calculates the group anomaly degree by using a difference between an estimated value calculated from a correlation at a normal state of a pair of the sensors the number of which is two and a measurement value of the pair of the sensors.

9. The anomaly analysis method according to claim 1 further comprising a step of detecting anomaly based on in what order the group anomaly degree of the plurality of groups increases.

10. A non-transitory storage medium in which an anomaly analysis program is stored, the program that causes a computer to perform:
generating at least one group of sensors for each hierarchy of a plurality of hierarchies;
calculating a group anomaly degree on the group basis from measurement values of the sensors included in the group; and
performing control of displaying a time-series change of the group anomaly degree in any one hierarchy of the plurality of hierarchies.

11. An anomaly analysis system comprising:
a group generation unit that generates at least one group of sensors for each hierarchy of a plurality of hierarchies;
a group anomaly degree calculation unit that calculates a group anomaly degree on the group basis from measurement values of the sensors included in the group; and
a display control unit that performs control of displaying a time-series change of the group anomaly degree in any one hierarchy of the plurality of hierarchies.
